(19) United States
(12) Patent Application Publication
(10) Pub. No.: US 2009/0153236 A1
(43) Pub. Date: Jun. 18, 2009

(54) POWER CONTROL CIRCUIT WITH LOW POWER CONSUMPTION

(75) Inventors: Franciscus Antonius Kneepkens, Eindhoven (AT); Peter Jan Slikkerveer, Eindhoven (AT); Pawel Musial, Gdynia (PL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,512

(22) PCT Filed: Oct. 18, 2005
(86) PCT No.: PCT/IB05/53410

§ 371 Date: Feb. 27, 2009

(30) Foreign Application Priority Data
Oct. 20, 2004 (EP) 04105196.2

(51) Int. Cl. G05F 1/10

(52) U.S. Cl. 327/544

(57) ABSTRACT

The available battery power on autonomously powered mobile electronic devices, in particular smartcards, is very small but requires a very long shelf life. Thus, even very small rest currents are a big power issue. The invention discloses a power save circuit and method, where a single power switch, e.g. a FET or a MEM switch, can be used to detach the power supply (?) from the whole system and allow the lowest current possible. Further, a combination with a double action button and integration of the power switch provides a solution with a minimum number of components and interconnects. An option for “system wake-up at any button” enables additional power saving during use, without inconvenience to the user.

### FIELD OF THE INVENTION

The present invention relates to a power save circuit, a power consumption reduction method, and a smartcard, a transponder, and a mobile autonomously powered electronic device.

### BACKGROUND OF THE INVENTION

In the field of autonomously powered electronic devices, miniaturization is an ongoing process as well as a desired goal, since more and more sophisticated functions can be integrated in handy electronic devices. Mobile phones, personal digital assistants (PDA), mobile digital assistants (MDA), as well as handheld GPS devices are examples of such mobile electronic devices, where it is clear that usability strongly depends on the form-factor and, thus, is a crucial aspect of user acceptance. Furthermore, electronics is emerging in daily life items where electronic functionality is a new feature. For instance, transponders in car keys or even the substitution of car keys by a transponder. The transponder associated with a key or a sole transponder functioning as a key provides better security than a mechanical key that can easily be copied. A further important field is that of smartcards, which will be discussed in more detail in the following.

A smartcard (hereinafter also referred to as card for short) is typically a device with a “credit card” sized form factor having a small embedded electronic functional circuit, for instance, a computer chip or the like. Such a card-computer may be programmed to perform tasks and/or to store information. In general, there are different types of smartcards, e.g. memory cards, processor cards, electronic purse cards, security cards etc. Nowadays, a smartcard with a processor circuit is usually adapted to be inserted into a so-called smartcard reader, also commonly called card terminal, and is then available for use. Software wishing to communicate with the reader needs to send some commands to control the reader, to provide functions, such as powering up or transferring commands to the smartcard. Commands sent to smartcards may be proprietary, but there is also a standard, namely the ISO 7816 specifications, which define command formats in great detail.

Smartcards help businesses evolve and expand their products and services in a rapidly changing global market. In addition to the well known commercial applications, for instance, banking, payments, access control, identification, ticketing and parking or toll collection etc., in recent years, the information age has introduced an array of security and privacy issues that have called for advanced smartcard security applications, e.g. secure log on and authentication of users to PC and networks, storage of digital certificates, passwords and credentials, encryption of sensitive data, wireless communication subscriber authentication, etc.

The newest generation of smartcards is developed for autonomous operation without a card terminal, i.e. a card-reader as described above. Thus, such a card requires an internal power source for operation. However, due to the dimensions of smartcards the power that can be made available inside the card is very small. Typically, the capacity of an internal power supply is in the order of 10 to 25 mAh. The common use profile of smartcards is short operation times, for instance 20 seconds, and about five operations per day with long time intervals of no operation in between. It goes without saying that it is crucial for the acceptance of such autonomous smartcards to be usable for several years without having to be exchanged for reason of a depleted battery. Even if recharging of the internal battery would be possible it could be forgotten and thus harm user acceptance. Hence, it is necessary to ensure a predetermined period of time during which enough “on board” power can be guaranteed. Since the total power available is so small it is very much desirable to have a minimum power usage, when the card is not used. Even a low rest current of 1 μA will consume 26 mAh over a period of 3 years. Considering an internal battery of 25 mAh, the power would not even be sufficient for a period of no operation of 3 years. However, this problem can not easily be solved by a larger battery, since the area of the card that is taken up by the battery is important. A smaller battery leaves more room for other components on the card and/or more room for “plastic” providing a better mechanical behaviour of the card.

There are two common approaches to reduce power loss, each having their own disadvantages. First, when the power supply to a functional circuit is maintained, i.e. the power supply is not switched off; the rest current drawn (?) by the total system then should at least be below 0.1 μA. However, this is not possible for the current generation of integrated circuits (IC) that are applied in smartcards. The most advanced low-power IC's are currently going to approach this kind of rest power. But even with a rest current in the order of 0.1 μA, 25% of the capacity of a 10 mAh battery is wasted in a 3 year time period. Therefore, the rest current should be preferably below 0.01 μA.

A second alternative is the use of an analog switch to disconnect the power supply, e.g. the battery, from the functional circuit, e.g. a processor. For instance, the processor may generate a signal that the power should be disconnected when it powers down. This solution usually consists of a number of transistors and has the drawback that the total leakage current of the transistors is too large. Moreover, in the known circuits, the transistor as a switching element within the power line has a significant on-resistance of several tens of Ohms, which additionally reduces the voltage that can be used for the supplied functional circuit. The simplest known circuit for switching the connection to the power supply is shown in FIG. 8. By a high signal at (I), transistor V2 opens and pulls the gate of transistor V1 to ground, thus causing transistor V1 to switch to conduction. At a low signal (I), transistor V2 closes and the pull-up resistor R brings the gate of transistor V1 to a high voltage, which closes transistor V1. This circuit can be recognized, for instance, in U.S. Pat. No. 5,198,851 in FIG. 12, where transistor V2 corresponds to FET 36 and the rest of the circuit, i.e. at least transistor V1, is in the DC/DC converter. In the circuit of FIG. 8, in the on-state of the supplied circuit, the resistor R consumes most power. Considering that realistic resistor values are 100 k to 1 M, the power usage is 3 to 30 μA at a supply voltage of 3 V, which is significant for very low power applications like the devices discussed herein, such as smartcards, transponders etc. In the power-offstate, in the circuit of FIG. 8, power usage is governed by the leakage current of the two transistors V1 and V2.

### OBJECT AND SUMMARY OF THE INVENTION

It is an objective of the present invention to provide a power save circuit that reduces power usage of a complete electronic device during off-state and has a minimum power usage during on-state.

A further objective is to avoid leakage currents whenever possible. Yet another objective is to use as few additional electrical elements as possible. Yet another further objective is to have a circuit solution which can be integrated within an existing integrated circuit and, thus, put into very small devices like smartcards, transponders, as well as mobile electronic devices or the like.

The objectives mentioned above are achieved by a power save circuit as described in the following section:

A power save circuit comprising start-up means, booster means, and a power switching means for connecting and disconnecting a power supply, wherein said start-up means are arranged to provide, on actuation, a temporary connection from said power supply to at least said booster means, which are arranged to generate a switching voltage which is out of a range of a supply voltage provided by said power supply for activation of said power switching means, wherein said power switching means are arranged to connect, on activation, said power supply to said booster means and to a functional circuit.

The objectives mentioned above are furthermore achieved by a power consumption reduction method as described in the following section:

Method for reduction of power consumption in a mobile electronic device having a functional circuit which is power supplied by a limited internal electric power supply having a supply voltage, said method comprising:

activating said mobile electronic device being in an off-state by the steps:

generating a switching voltage out of the range of said supply voltage;

activating a switching element by said switching voltage; and

connecting said power supply to said functional circuit by said switching element;

shutting down said mobile electronic device being in an on-state by the steps: stopping said generating of said switching voltage and thus breaking said switching element.

The objectives mentioned above are furthermore achieved by a smartcard comprising a power save circuit as defined above.

The objectives mentioned above are furthermore achieved by a transponder comprising a power save circuit as defined above.

The objectives mentioned above are furthermore achieved by a mobile autonomously powered electronic device comprising a power save circuit as defined above, wherein said functional circuit is a not permanently used part of said electronic device.

Accordingly, a power save circuit comprises start-up means, booster means, and a power switching means for connecting and disconnecting a power supply, wherein said start-up means are arranged to provide, on actuation, a temporary connection from said power supply to at least said booster means, which are arranged to generate a switching voltage which is out of the range of a supply voltage provided by said power supply for activation of said power switching means; in other words, mathematically speaking the absolute value of said generated switching voltage is greater than the absolute value of said supply voltage. Said power switching means are arranged to connect, on activation, said power supply to said booster means and to a functional circuit. Said power supply takes the form of power supply means, which can be any kind of power supply providing autonomously a supply voltage and are preferably a battery or an accumulator. It is noted that a switching voltage being out of the range of the supply voltage means that said switching voltage is higher than the supply voltage provided by said power supply or is lower than the supply voltage provided by said power supply.

Said power switching means are a single switching element. Said power switching means can be any kind of semiconductor switching element. Preferably, said semiconductor switching element is a single field effect transistor (FET). It is also possible that said power switching means are a miniaturized switch, i.e. on the scale of integrated circuits. Preferably, such a miniaturized switch is a miniaturized electromechanical switch (MEMS). More preferably, such a miniaturized electromechanical switch is an electrostatic switch or a piezoelectric switch.

Said booster means are a voltage boosting circuit generating said switching voltage from said supply voltage. In one embodiment of the invention, the switching means are arranged for switching a power connection to the positive supply line of the power supply and said switching voltage is a higher voltage than said supply voltage. In another embodiment of the invention, said switching means are arranged for switching a power connection to the negative supply line of the power supply and said switching voltage is a lower voltage than said supply voltage. Said higher voltage or lower voltage, respectively, may be generated from a signal provided by said functional circuit, which may be a clock signal. For that purpose, the boosting circuit may be a charge pump which uses said clock signal for the generation of the needed switching voltage.

Said functional circuit may comprise at least a processing circuit or a display driving circuit. It is to be noted that said functional circuit can be any kind of applicable circuit for the device, e.g. a sound generating circuit, a sensor circuit, e.g. for sensing biometrical features of a user such as a fingerprint, a solar cell, a light emitting element etc. According to a preferred embodiment of the invention, said functional circuit comprises said booster means. Said functional circuit may comprise at least said display driver in which said booster means are available. It is also possible that said functional circuit comprises at least said processing circuit in which said booster means are available. In said booster means within a processing circuit there may be a circuit which is originally used for programming an electronically erasable programmable read only memory (EEPROM) or a flash memory. A lower or higher voltage than the reference potential can be used from a processor that contains non-volatile memories. There, a higher voltage is used for writing data to an EEPROM or flash memory. For instance, the voltages available for EEPROM usually are between 10 and 15 V and those for flash memories are about 15V, both negative and positive. Thus, such voltages can advantageously be re-used as a switching voltage according to the invention.

Said start-up means can be a push-button, which can be any kind of push button. Preferably, a push-button is constructed as a simple conductive rubber pad pressed over a pattern of conductors, which form a respective input and output.

In a further development, said push-button is further arranged for acting as an input means for said functional circuit. For this purpose, said push-button may comprise an input coupled to said power supply, a first output coupled to said booster means and a second output coupled to an input of a functional circuit. Moreover, said push-button is arranged such that on actuation of said push-button said input is connected to both said first and said second output.

According to the method for reduction of power consumption in a mobile electronic device, said device has a functional circuit that is power supplied by a limited internal electric power supply, which has a predetermined supply voltage. Said method comprises, when activating said mobile electronic device being in an off-state, the following steps: creating a higher voltage than said supply voltage; activating a switching element by said higher voltage; and connecting said supply voltage to said functional circuit by said switching element. Said method comprises, when shutting down said mobile electronic device being in an on-state, the following steps: stopping said generation of said higher voltage and breaking said switching element. Said breaking step may be initiated by an external input activity, which for example can be actuation of an OFF push-button. It is also possible that said breaking step is initiated by a predetermined internal event, e.g. when a predetermined time of a timer has elapsed or a process or operation is completed in said functional circuit.

The power save circuit according to the present invention may most advantageously be used in a smartcard, a transponder as well as a mobile autonomously powered electronic device.

In general, the present invention uses a single power switching element, for instance, a FET (field effect transistor) or a MEMS (miniature electromagnetic switch) as a power switch to allow disconnecting the battery from the functional circuit, i.e. the whole electronic system. Advantageously, the single FET or the single MEMS allows the least possible leakage current, with a very low on-resistance. According to the invention, for switching of a MEMS a voltage is used higher than the voltage of the power supply to be switched and for switching of a FET a voltage is used higher or lower, respectively, than the voltage of the power supply to be switched, depending on the fact whether the FET is used to switch a power connection line to the high or low potential provided by the power supply. The needed higher or lower voltage is generated by booster means, e.g. a voltage boosting circuit, for as long as the whole device or system is in operation, i.e. in an on-state. The circuit according to the invention does have a very significantly lower power usage, since the power switch, i.e. the FET or the MEMS, itself does not use power; only the leakage current in the booster circuit is left, which is at least a factor of 10 lower than that of the circuit in FIG. 10. Most advantageously, when the needed boosting circuit is already available, i.e. a higher voltage (HV) or lower voltage (LV) is already available; there is no additional power consumption, at all. The HV or LV may already be present in the functional circuit, e.g. in a display driver, where it is used for driving a display, so the only additional electronic component is a FET or MEMS. Some processors may also have a HV or a LV already available, e.g. for writing an electronically erasable programmable read only memory (EEPROM) or flash memory, which could also be re-used as switching voltage. Advantageously, by using the internal clock of the processor as source for the booster circuit, there is no need for an extra I/O pin to control the power switch. When the processor goes into shutdown, its clock will stop and hence the power switch will disconnect the processor from the battery (supply) automatically.

The preferred embodiment of the present invention only contains a single FET, reducing the leakage current by a factor of 2 in comparison with the prior art of FIG. 10. The higher voltage for operation of the switch also allows using an electrostatic or piezoelectric MEM switch instead of a FET. A MEM switch consumes no power at the on-state and has almost no leakage at the off-state.

### BRIEF DESCRIPTION OF THE DRAWINGS

The present invention will now be described on the basis of embodiments with reference to the accompanying drawings, in which:

FIG. 1 shows the general principle of the power save circuit according to the present invention;

FIG. 2 shows a block diagram of a first embodiment of the present invention;

FIG. 3 shows an example of an embodiment of a boosting circuit for the generation of a high voltage;

FIG. 4 shows a block diagram of a further development of the first embodiment of the present invention;

FIG. 5 shows an example of a switching pattern of a double action button, which is usable in the second embodiment of the present invention;

FIG. 6 shows a block diagram of an alternative of the further development of the first embodiment of the present invention;

FIG. 7 shows a block diagram of the preferred embodiment of the present invention;

FIG. 8 shows a block diagram of a second embodiment of the present invention;

FIG. 9 shows an example of an embodiment of a boosting circuit for the generation of a low voltage; and

FIG. 10 shows a simplified circuit according to the prior art.

### DESCRIPTION OF EMBODIMENTS

First, it is to be noted that it goes without saying that a voltage is correctly defined as a difference of potentials between two particular nodes of a circuit. However, as soon as a certain node is defined as being the reference potential, i.e. a reference node, the potential of any other node in the circuit can be referenced by its voltage defined by the difference between its potential and the potential of the reference node. Therefore, for relief of complexity in the description of the embodiments of the invention, nodes of the circuits are referenced by their voltage in comparison with the reference potential Vref.

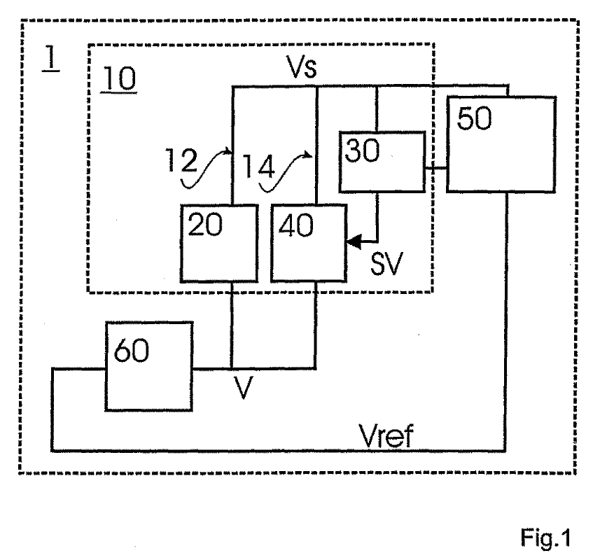

Now reference is made to FIG. 1 that shows the general principle of the power save circuit according to the present invention. Accordingly, a system or device 1 comprises a power save circuit 10 according to the present invention. The power save circuit 10 has start-up means 20, booster means 30, and a power switching means 40 for connecting and disconnecting a supply voltage V provided by a power supply 60, which further provides the reference potential Vref. The start-up means 20 are arranged to provide, on activation, a temporary connection 12 from the supply voltage V to at least the booster means 30. The booster means 30 are arranged to generate a switching voltage SV, which can be a higher voltage HV or a lower voltage LV in comparison with the supply voltage V, depending on the fact whether the switching means 40 are used to switch a negative supply voltage V or a positive supply voltage V. The switching voltage VS is used for activation of the power switching means 40. The power switching means 40 are arranged to connect, on activation, the supply voltage V to the booster means 30 and a functional circuit 50 via a power supply line 14. Hence, the supply voltage V is input to both the booster means 30 and the functional circuit 50 as long as the booster means 30 generate the switching voltage SV. The power supply means 60 preferably are a battery or an accumulator. Finally, the reference potential Vref is coupled at least to the functional circuit 50. It is also possible that the booster means 30 are also coupled to the reference potential Vref. The reference potential is commonly referred to as ground potential GND.

Now reference is made to FIG. 2 that shows a block diagram of a first embodiment of the present invention. The system or device 1 may be a smartcard. Basically, in comparison with FIG. 1, a FET 44 and a push-button 22 are used in place of the power switching means 40 and start-up means 40, respectively, in FIG. 1. Further, as can also be seen from the battery 62, the supply voltage V is higher than the reference potential Vref. Hence, the FET 44 has to switch the connection between the positive supply voltage line Vpp and the supply voltage V of the battery 62. Therefore, for switching the FET 44, the switching voltage has to be higher than the supply voltage V, i.e. a higher voltage HV according to the invention.

The device 1 operates as follows. When the push-button 22 is pressed, it connects Vpp of the functional circuit, being a processor 54, to V of the battery 62, causing the processor 54 to start-up. As part of the start-up procedure the processor 54 provides a signal 52 to the booster means 30. The signal 52 may initiate a clock of the booster means 31 or may supply a clock signal to the booster means 30, e.g. the processor clock itself. With a clock started or clock signal supplied, respectively, the booster means 31 generate the required higher voltage HV, which opens the FET 44. The FET 44 will maintain the power supply line 14 when the push-button 22 is released. When the device 1 has to be (?) switched off, the processor 54 either stops the clock at the booster means 31 or stops supplying a clock to the booster means 31. Then the generation of the higher voltage HV is stopped, resulting in a breakdown of the higher voltage HV. The FET 44 will fall off and the complete device 1 will be detached from the power supply and, thus, consume nearly zero power. More advantageously, the FET 44 and the functional circuit, i.e. the processor 54, can be integrated together on a processor module. If use is also made of (?) the internal clock of the processor as source for the booster circuit, there is no need for an extra I/O pin to control the power switch. When the processor goes into shutdown, its clock will stop and hence the power switch will disconnect the processor from the battery (supply) automatically.

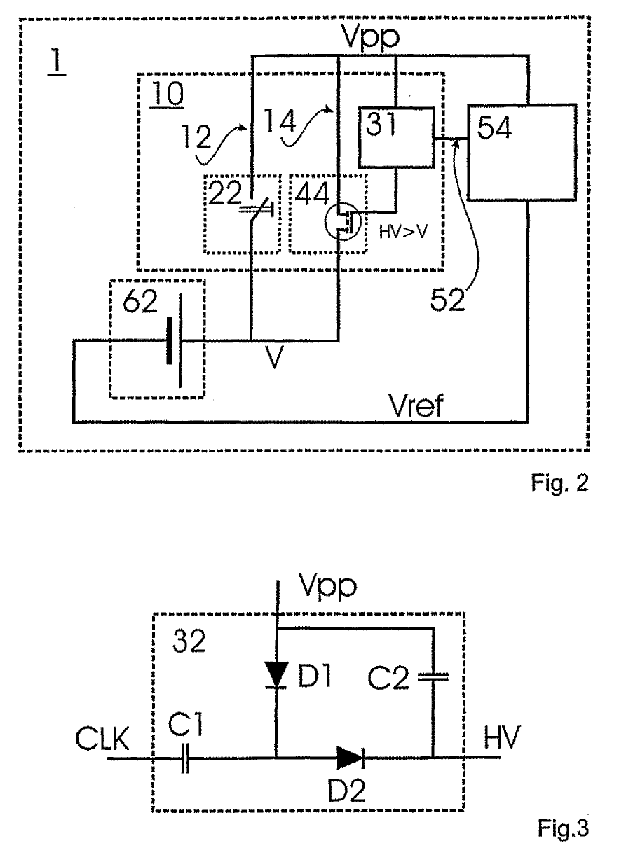

When the processor 54 provides a clock signal, the booster means 31, in FIG. 2, can be as simple as the boosting circuit 32 shown in FIG. 3. The signal 52 of FIG. 2, being a clock signal, is input at the terminal CLK of the boosting circuit 32. When the signal is provided at the terminal CLK, the boosting circuit 32 works as a simple one-step charge pump and provides the needed high voltage at the terminal HV that is used to open the FET 44 of FIG. 2. It is to be noted that, depending on the capacity of capacitor C2, the signal at the CLK terminal supplied from the processor 54 in FIG. 2 to the booster circuit 32 could be re-used for example as a data line or I/O line for external communication to the device 1. Since ICs used as processors on devices like smartcards have notoriously few external interconnects, re-use of an existing terminal is advantageous due to the limited number of external interconnects to the processor 54 of the device 1.

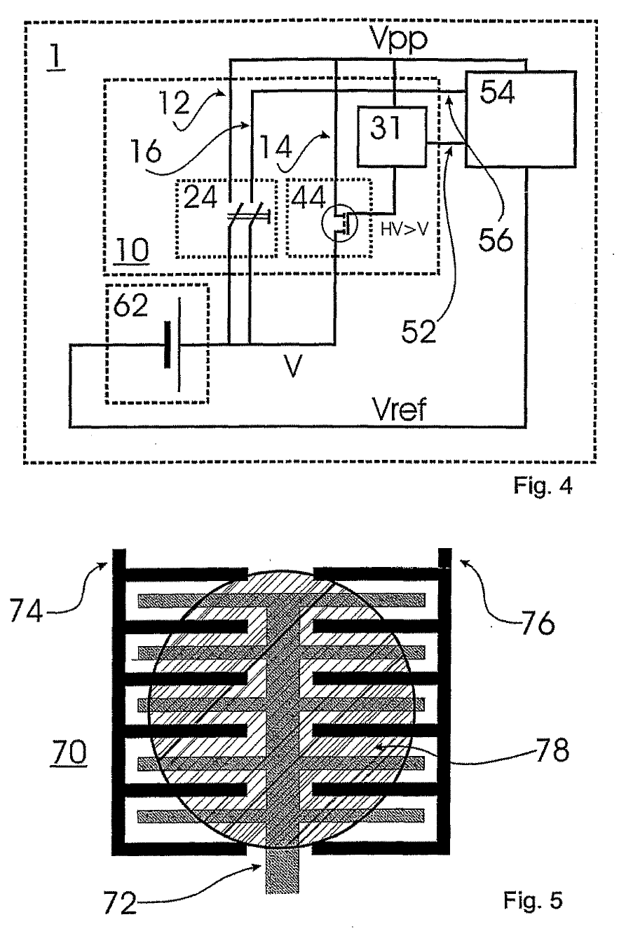

Now reference is made to FIG. 4, which shows a block diagram of a further development of the first embodiment of the present invention. In comparison with the first embodiment of FIG. 2, in FIG. 4 the push-button 24 of the start-up means provides a bi-functionality, i.e. the push-button 24 can be used for two functions. A first function is the activation of the device 1 and a second function is the provision of an external input means for the functional circuit on the devices 1. In other words, the start-up means are re-used as input means for the processor 54, i.e. the functional circuit 50 of FIG. 1. Thus, the push-button 24 is a “double action” push button. When the double action push-button 24 is pressed, contact is made between V and both the supply voltage Vpp of the processor 54 and an input pin 56 of the processor 54 via an input signal line 16.

The double action push-button 24 may be realized as shown in FIG. 5, which is a schematic plan view of a possible implementation. On actuation, a simple conductive rubber pad 78 is pressed on a pattern of conductors, which are an input conductor pattern 72 and a first output conductor pattern 72 and a second output conductor pattern 74 of a double action push-button 70 as sketched in FIG. 5. It is to be noted that the conductive rubber pad may have any shape as long as enough coverage of the conductor patterns 72, 74, and 76 is provided. It is noted that providing this bi-functionality of a push-button can also be realized by any applicable combination of two single push-button switches. However, there are also other ways one of which will be described below.

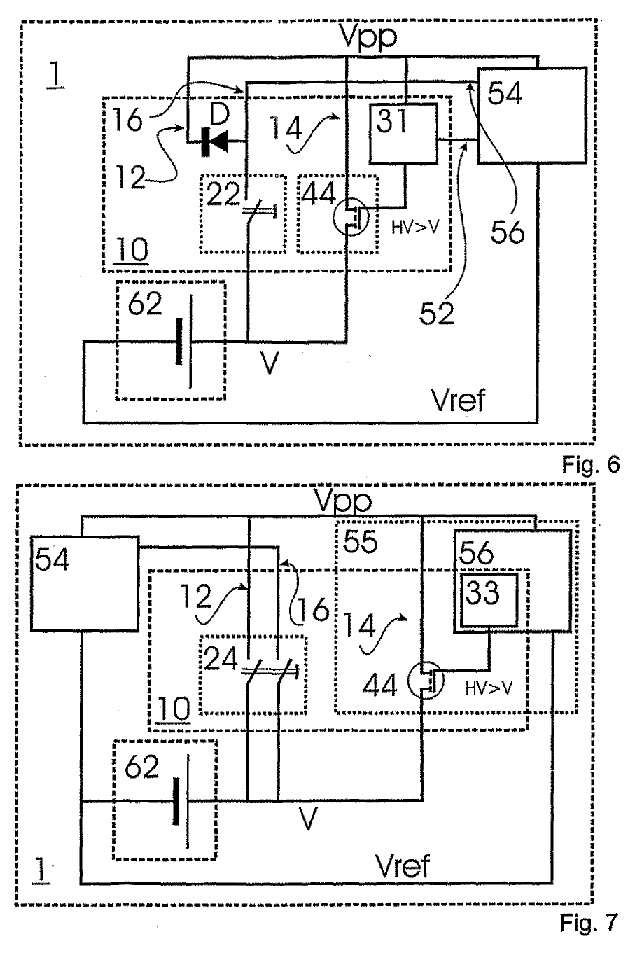

The second embodiment of FIG. 4 has two great advantages for use in devices like smartcards or transponders etc. The limited space in such devices only allows a limited number of buttons, e.g. two or three. Re-using the start-up means, i.e. the push button, reduces the necessary number of buttons. Hence, more space on the smartcard or transponder is available for other functions. Alternatively, an additional push-button for the same required space is possible, which enhances the user-friendliness of the device. It is noted that the double action push-button can advantageously be incorporated in all buttons of the device 1, allowing start-up at “ANY BUTTON PRESSED”. In case the functional circuit comprises more than a processor 54, this allows the processor 54 or the complete device 1 to switch off when they are no longer needed in order to save power. Since any depressed double action push-button 24 will wake up the device 1, any inconvenience to the user is avoided, which would not be the case if he or she has to press a certain on-switch each time the device 1 has switched off. FIG. 6 shows a block diagram of an alternative to the second embodiment of the present invention. Here, placing a diode D between the start-up power line 12 and the input signal line 16 provides the double action functionality.

Now reference is made to FIG. 7, which shows a block diagram of a preferred embodiment of the present invention. In the preferred embodiment the power switching FET 44 is not positioned on a processor module together with the processor 54, instead the power switching FET 44 is positioned on a respective display module 55 together with a display driver 56. Whilst, according to the embodiments described above, the higher voltage HV for opening the FET 44 has been generated by the additional booster means 31 (FIGS. 2, 4, 6), this is not necessary with most display modules. Most display principles, e.g. LCD and electrophoretic displays, require a higher voltage than the voltage from the battery and/or the processor core voltage for an optical response. Thus, if the display driver 54 on the display module 55 already has a boosting circuit, then this boosting circuit can also be used for generating the necessary higher voltage HV compared to the supply voltage V. It is also possible that the display module 55 comprises one or more display drivers and a booster circuit separated from each other. That is, the display driver ICs or at least the display module contains a booster circuit 33 which is re-used as the booster means according to the invention to open the FET 44. Further, it is to be noted that the FET 44 can also be integrated in the display module 55 together with the display driver 54.

The operation procedure will now be described in detail with reference to FIG. 7. When the double action push-button 24 is pressed, the processor 54 and a display driver 56 get power from the battery 62 via the temporary connection 12 and start-up. As part of the start-up procedure the processor 54 initiates the display driver 56 and the booster circuit 33 before (?) the display is started. Alternatively, the processor 54 may provide a clock signal to the booster circuit 33 at the display driver 56. The high voltage HV of booster circuit 33 within the display driver 56 opens the FET 44, which will maintain the power connection 14 when the push-button 24 is released. When the device 1 (or system), i.e. the display smartcard, is to be switched off, the processor 54 can switch off the booster circuit 33 at the display driver 56, e.g. by issuing a RESET command to the display driver 56. The FET 44 will fall off and the complete device 1 will consume nearly zero power. It is to be noted that the preferred embodiment could also be combined with the “ANY BUTTON PRESSED” wake-up, described in the previous embodiment, i.e. the alternative realization of the double action push-button functionality.

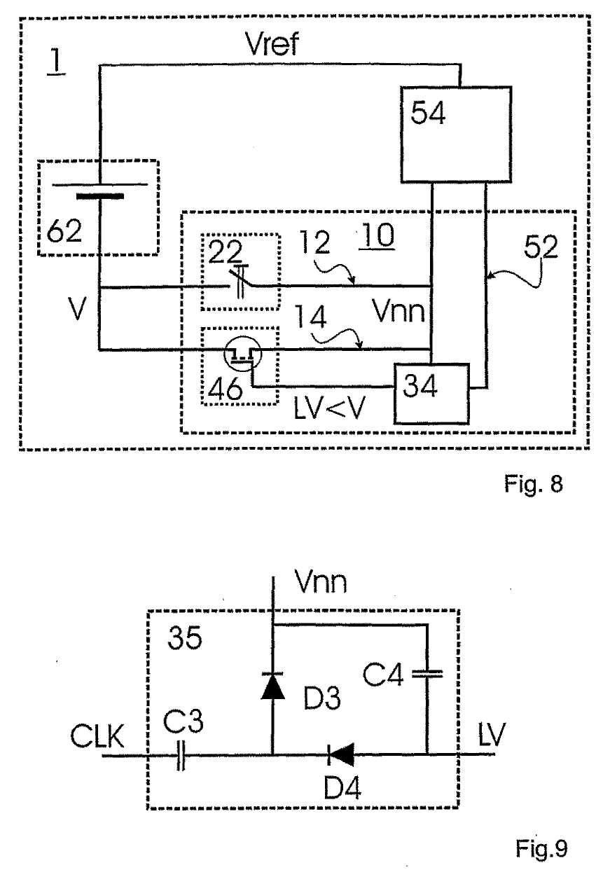

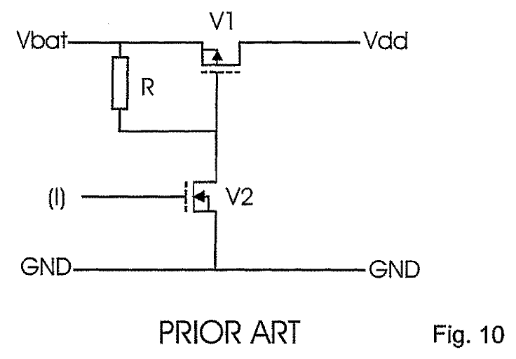

Now reference is made to FIG. 8 that shows a block diagram of a second embodiment of the present invention. Now, as can also be seen from the polarity of the battery 62, the supply voltage V is lower than the reference potential Vref. Hence, the FET 46 has to switch the connection between the negative supply voltage line Vnn and the supply voltage V of the battery 62. Therefore, for switching the FET 46, the switching voltage has to be lower than the supply voltage V, i.e. a lower voltage LV according to the invention. The device 1 of FIG. 8 operates as follows. When the push-button 22 is pressed, it connects Vnn of the functional circuit, for instance, being a processor 54, to V of the battery 62, causing the processor 54 to start-up. As described above, the processor 54 provides a signal 52, e.g. a clock signal, to the booster means 34. With the supplied clock signal the booster means 34 (?) generate the required lower voltage LV, which opens the FET 46, which maintains the power supply line 14 when the push-button 22 is released. For switching of the device 1, the processor 54 may stop providing the clock signal to the booster means 34, causing also the generation of the lower voltage LV to stop. Hence, breakdown of the lower voltage LV causes the FET 46 to fall off, and the complete device 1 will be detached from the power supply. Thus, there is nearly no power consumption. More advantageously, the FET 46 and the functional circuit, e.g. the processor 54, can also be integrated together on a processor module. If use is made of the internal clock of the processor as source for the booster circuit, there is no need for an extra I/O pin to control the FET 46. When the processor 54 goes into shutdown, its clock will stop and hence the FET 46 will disconnect the processor 54 from the battery 62 automatically. When the processor 54 provides a clock signal, the booster means 34, in FIG. 8, can be a simple circuit, such as the boosting circuit 35 shown in FIG. 9. The signal 52 of FIG. 8, i.e. the clock signal, is input at the terminal CLK of the boosting circuit 35. The boosting circuit 35 (similar to the one in FIG. 3) works as a simple one-step charge pump and provides the needed low voltage at the terminal LV that is used to open the FET 46 of FIG. 8.

It is noted that in each of the embodiments of the present invention discussed herein, instead of a semiconductor switch as the power switching means a MEM switch can be used for creating an open or closed switch in the power supply line 14 (FIGS. 1, 2, 3, 6, 7, 8). The basic structure of such a MEM series switch may, for instance, consist of a conductive beam suspended over a break (a mechanical gap) in the power supply line. Upon application of the switching voltage, i.e. the higher voltage HV, created by the booster circuit, an electrostatic force is induced on the beam, which lowers the beam across the gap, shorting together open ends of the power supply line. Upon removal of the higher voltage HV, a mechanical spring restoring force in the beam may return it to its suspended position. Advantageously, closed-circuit losses are minimal, i.e. only dielectric and I2r losses in the power supply line and dc contacts, and the open-circuit isolation from the break, e.g. a 100 μm gap, is very high.

In summary, since the available battery power on autonomously powered mobile electronic devices is very small but requires a very long shelf life, even very small rest currents are a big power issue. Accordingly, the present invention has disclosed a power save circuit and method where a single power switch, e.g. a FET or a MEM switch, is used to detach the power supply (?) from the whole system and allow the lowest rest-current possible. Further, a combination with a double action button and integration of the power switch provides a solution with a minimum number of components and a minimum of interconnects. An option for “system wake-up at any button” opens possibilities for additional power saving during use, without any inconvenience to the user.

Finally, yet importantly, it is noted that the term “comprising” when used in the specification including the claims is intended to specify the presence of stated features, means, steps or components, but does not exclude the presence or addition of one or more other features, means, steps, components or groups thereof. Further, the word “a” or “an” preceding an element in a claim does not exclude the presence of a plurality of such elements. Moreover, any reference signs do not limit the scope of the claims. Furthermore, it is to be noted that “coupled” is to be understood to mean that there is a current path between those elements that are coupled; i. e. “coupled” does not mean that those elements are directly connected.

1. A power save circuit (10) comprising start-up means (20), booster means (30), and a power switching means (40) for connecting and disconnecting a power supply (60), wherein said start-up means (20) are arranged to provide, on actuation, a temporary connection (12) from said power supply (60) to at least said booster means (30), which are arranged to generate a switching voltage (SV) which is out of a range of a supply voltage (V) provided by said power supply (60) for activation of said power switching means (40), wherein said power switching means (40) are arranged to connect, on activation, said power supply (60) to said booster means (30) and to a functional circuit (50).

2. Circuit according to claim 1, wherein said start-up means (20) are a push-button (22).

3. Circuit according to claim 1, wherein said start-up means (20) are further arranged for acting as an input means for said functional circuit (54).

4. Circuit according to claim 3, wherein said start-up means (20) are a push-button (24) comprising an input (72) coupled to said supply voltage (V), a first output (74) coupled to said booster means (30) and a second output (76) coupled to an input of a functional circuit (54), and said push-button is arranged such that on actuation of said push-button (24) said input (72) is connected to both of said first (74) and said second (76) output.

5. Circuit according to claim 1, wherein said power switching means (40) are a single semiconductor switching element (44; 46), preferably a field effect transistor.

6. Circuit according to claim 1, wherein said power switching means (40) are a single miniaturized switch, preferably a miniaturized electromechanical switch.

7. Circuit according to claim 6, wherein said miniaturized electromechanical switch is an electrostatic switch or a piezoelectric switch.

8. Circuit according to claim 1, wherein said booster means (30) is a voltage boosting circuit (32) generating said switching voltage (SV), which is a higher voltage (HV) than said supply voltage (V) to be switched.

9. Circuit according to claim 1, wherein said booster means (30) is a voltage boosting circuit (34) generating said switching voltage (SV), which is a lower voltage (LV) than said supply voltage (V) to be switched.

10. Circuit according to claim 8, wherein said functional circuitry provides a clock signal to said booster means.

11. Circuit according to claim 1, wherein said functional circuit (50) comprises at least a processing circuit (54) or a display driving circuit (56).

12. Circuit according to claim 11, wherein said processing circuit or said display driving circuit comprises said booster means.

13. Circuit according to claim 1, wherein said power supply (60) is a battery or an accumulator.

14. Method for reduction of power consumption in a mobile electronic device having a functional circuit which is power supplied by a limited internal electric power supply having a supply voltage, said method comprising:
activating said mobile electronic device being in an off-state by the following steps:
generating a switching voltage out of the range of said supply voltage;
activating a switching element by said switching voltage; and
connecting said power supply to said functional circuit by said switching element;
shutting down said mobile electronic device being in an on-state by the following steps:
stopping said generating of said switching voltage and thus breaking said switching element.

15. Method according to claim 14, wherein said breaking step is initiated by an external input activity.

16. Method according to claim 14, wherein said breaking step is initiated by a predetermined internal event.

17. A smartcard comprising a power save circuit according to claim 1.

18. A transponder comprising a power save circuit according to claim 1.

19. A mobile autonomously powered electronic device comprising a power save circuit according to claim 1, wherein said functional circuit is a not permanently used part of said electronic device.
